(19) United States
(12) Patent Application Publication
(10) Pub. No.: US 2026/0332225 A1
(43) Pub. Date: Oct. 22, 2026

(54) METHOD AND APPARATUS FOR BEAM SELECTION FOR BEAM REPORT IN A WIRELESS COMMUNICATION SYSTEM

(71) Applicant: ASUS Technology Licensing Inc., Taipei City (TW)

(72) Inventor: Yi-Hsuan Kung, Taipei City (TW)

(21) Appl. No.: 19/646,394

(22) Filed: Apr. 13, 2026

Related U.S. Application Data
(60) Provisional application No. 63/792,726, filed on Apr. 22, 2025.

(51) Int. Cl. H04B 7/06; H04B 7/0408; H04W 24/10

(52) U.S. Cl. CPC H04B 7/0639; H04B 7/0408; H04B 7/0626; H04B 7/06952; H04W 24/10

(57) ABSTRACT

Methods, systems, and apparatuses are provided for beam reporting in a wireless communication system, wherein a method of a UE comprises being configured with an event-triggered report configuration associated with one or more beams, determining to generate a truncated beam report Medium Access Control (MAC) Control Element (CE) in response to one or more triggered measurement reporting associated with the event-triggered report configuration, and determining which beams among the one or more beams to be included in the truncated beam report MAC CE based on at least a type of each of the one or more beams.

### CROSS-REFERENCE TO RELATED APPLICATIONS

The present Application claims priority to and the benefit of U.S. Provisional Patent Application Ser. No. 63/792,726, filed Apr. 22, 2025, which is hereby fully incorporated herein by reference.

### FIELD

This disclosure generally relates to wireless communication networks and, more particularly, to a method and apparatus for beam reporting in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for beam reporting in a wireless communication system. As such, the present invention provides beam selection methods for reporting measurement reports for User Equipment (UE)-initiated or event-triggered beam reports.

In various embodiments, a method of a UE comprises being configured with an event-triggered report configuration associated with one or more beams, determining to generate a truncated beam report Medium Access Control (MAC) Control Element (CE) in response to one or more triggered measurement reporting associated with the event-triggered report configuration, and determining which beams among the one or more beams to be included in the truncated beam report MAC CE based on at least a type of each of the one or more beams, wherein: the UE prioritizes a first type of the one or more beams over a second type of the one or more beams, prioritizes the second type of the one or more beams over a third type of the one or more beams, and prioritizes the third type of the one or more beams over a fourth type of the one or more beams, and wherein: the first type of the one or more beams is one or more beams that fulfill an entry condition of the event-triggered report configuration and trigger the truncated beam report MAC CE, the second type of the one or more beams is one or more beams that fulfill a leaving condition of the event-triggered report configuration and trigger the truncated beam report MAC CE, the third type of the one or more beams is one or more beams that do not trigger the truncated beam report MAC CE and have been reported in a previous beam report MAC CE, and the fourth type of the one or more beams is one or more beams that do not trigger the truncated beam report MAC CE and have not been reported in a previous beam report MAC CE, in accordance with embodiments of the present invention.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is an example diagram showing that the UE could be configured with 6 beams, Beam 1 to Beam 6, for a report configuration for event triggered measurement reporting, in accordance with embodiments of the present invention.

FIG. 6 is an example diagram showing that when prioritizing triggered beams first, the UE could include triggered beams first (beam 2 to 4) before including other beams, in accordance with embodiments of the present invention.

FIG. 7 is an example diagram showing that the UE could first prioritize including a first triggered beam fulfilling the entering condition, and then prioritizing including a second triggered beam fulfilling the leaving condition, and then includes a third triggered beam fulfilling the entering condition, and so on, in accordance with embodiments of the present invention.

FIG. 8 is an example diagram showing that for a truncated beam report, the UE could prioritize selecting one triggered beam to report (e.g., best quality triggered beam) and select other beams based on quality (e.g., beam 2 is first selected, and then beam 1 and beam 5 are selected based on quality), and/or the triggered beam selection could be based on prioritizing selecting a beam satisfying an entering condition over a beam satisfying leaving condition, in accordance with embodiments of the present invention.

FIG. 9 is a flow diagram of a method of a UE in a wireless communication system comprising triggering or initiating a measurement reporting associated with a reporting configuration in response to one or more triggered beams, and determining whether to prioritize including or selecting a first beam into a beam report (over a second beam) based on at least one of: quality of the first beam (and/or the second beam), type of the first beam (and/or the second beam), and/or index of the first beam (and/or the second beam), in accordance with embodiments of the present invention.

FIG. 10 is a flow diagram of a method of a UE in a wireless communication system comprising triggering or initiating a measurement reporting associated with a reporting configuration in response to one or more triggered beams, (prioritizing) including a first beam in a beam report associated with the report configuration, (after the first beam is included), including one or more second beams in the beam report, and (after the second beams are included) including one or more third beams in the beam report, in accordance with embodiments of the present invention.

FIG. 11 is a flow diagram of a method of a UE in a wireless communication system comprising being configured with an event-triggered report configuration associated with one or more beams, determining to generate a truncated beam report MAC CE in response to one or more triggered measurement reporting associated with the event-triggered report configuration, and determining which beams among the one or more beams to be included in the truncated beam report MAC CE based on at least a type of each of the one or more beams, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-242356; [2] Draft_RAN2_128_Meeting_Report; [3] R2-2502158 Running MAC CR for Mob Ph4; [4] R2-2502096 introduction of event-triggered meas report for RRC; and [5] 3GPP RAN2#129bis meeting report. The standards and documents listed above are hereby expressly and fully incorporated herein by reference in their entirety.

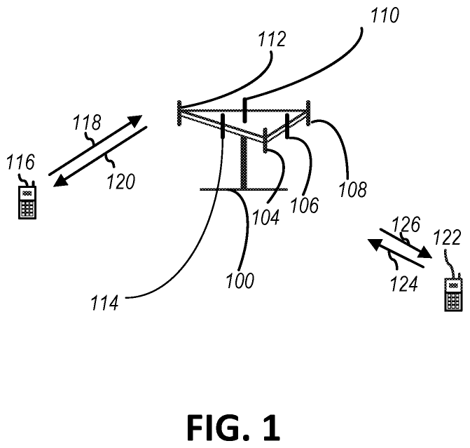

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

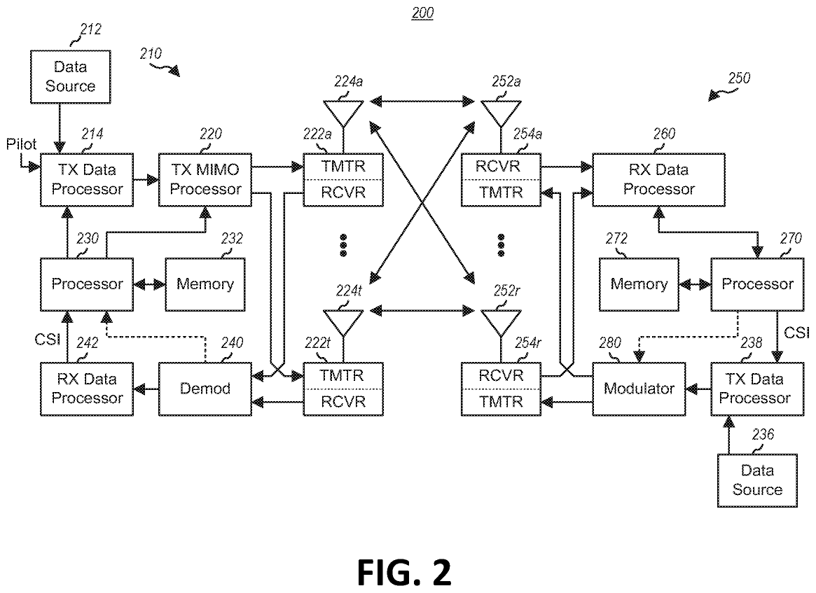

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

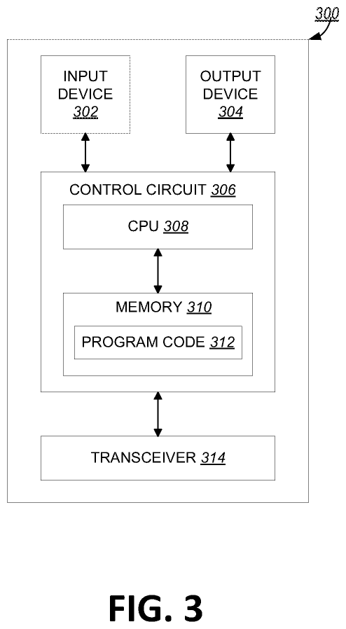

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

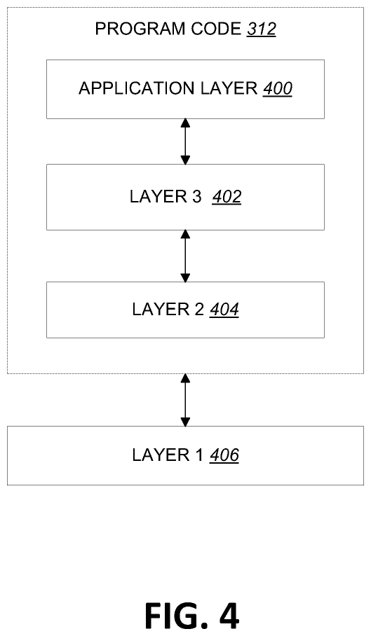

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-) bullets, points, actions, or claims described in each invention paragraph or section may be combined logically, reasonably, and properly to form a specific method.

Any sentence, paragraph, (sub-) bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In WID for mobility enhancement ([1] RP-242356), event-triggered measurement reporting and conditional LTM are introduced:

### 3 Justification

Layer 1/Layer 2 Triggered mobility (LTM) was introduced in Rel-18 and can offer improvements in handover latency and interruption time compared to Layer 3 based mobility. However, LTM as introduced in Rel-18 also has a number of limitations compared to Layer 3 mobility. This Rel-19 work item aims to remove a number of these limitations. LTM operation is only supported for mobility between cells of the same gNB (same CU). Depending on the deployment of the network this may significantly limit the opportunities to use LTM. By enabling LTM operation between cells of different gNBs (i.e. inter-CU) then the network will be able gain the benefits of LTM for a far greater number of handovers.

Layer 3 mobility uses layer 3 measurement reporting which supports UE evaluated events for triggering of measurement reports and reduces signalling overhead compared to periodic measurement reporting. Such event triggering is not supported by the L1 measurements that are used for LTM mobility.

L1 measurements for LTM procedures are limited to SSB measurements. Expanding L1 measurements to include CSI-RS can address this limitation and can be expected to enable greater throughput on the target cell immediately after cell switch.

Layer 3 mobility has evolved over several releases. Conditional handover (CHO) and other conditional mobility procedures (CPAC, SCPAC) were developed to achieve high robustness by enabling the procedure to be executed without necessitating a signalling exchange with source cell beforehand. LTM as introduced in Rel-18 offers short interruption time but not with the same level of robustness as the conditional L3 mobility procedures. In Rel-19, enhancements should be specified so that the system can benefit from both the high robustness and short interruption.

. . .
4.1 Objective of SI or Core part WI or Testing part WI
Specify support for inter-CU Layer1/Layer 2 Triggered Mobility (LTM) [RAN2, RAN3]
   Prioritize the case when CU is acting as MN when DC is not configured
   When DC is configured, inter-CU LTM can be configured either in MN or in SN but not both at the same time. For such cases:
      As secondary priority, support the case where CU is acting as SN and MN is unchanged
      As secondary priority, support the case where CU is acting as MN and SN is unchanged or SN is released
   Specify support for subsequent LTM mobility procedures aiming to avoid RRC configuration between cell switches as per Rel-18 LTM
      Coordination with SA3 needed with respect to security key handling
   Note: Rel. 18 intra-CU LTM procedure is considered as baseline for adding inter-CU support
Measurements related enhancements for purpose of supporting LTM: [RAN2, RAN1]
   Measurement related enhancements are applicable to Intra-CU MCG/SCG LTM and Inter-CU MCG/SCG LTM
   Specify necessary components to support event triggered L1 measurement reporting [RAN2, RAN1]
   Specify support for CSI-RS measurements for LTM procedures and enable CSI-RS based beam management [RAN1]
   Specify CSI acquisition on candidate cell(s) based on CSI-RS before or during LTM cell switch [RAN1]
      . . .
Specify support of conditional Intra-CU LTM [RAN2, RAN3, RAN1]
   Specify UE evaluated conditions for triggering LTM
   Aim to support conditional LTM including subsequent LTM
   Limit specifying the conditional LTM to the scenario where the UE is in non-DC
   Checkpoint at RAN#107 to review the objective on whether Intra-CU conditional LTM can be specified to DC scenarios and if so, to which cases. RAN WG work to not start before this checkpoint

In 3GPP meeting RAN2#128 ([2] Draft_RAN2_128_Meeting_Report), agreements were made regarding conditional LTM:

### Agreements on C-LTM:

1. The triggering condition of conditional LTM can be based on L3 measurement.
2. CondEventA3 and CondEventA5 conditions can be baseline for the conditional LTM execution.
3. The L1 execution condition of a candidate cell is associated to only one triggering event.
4. For L3 execution condition, it may consist of one or two triggering condition(s). If there are two triggering conditions associated with the same candidate cell, the UE shall consider the execution condition is fulfilled only when both triggering conditions are met. Only single RS type is supported and at most two different trigger quantities can be configured simultaneously for the evaluation of execution condition of a single candidate cell.
5. To support initial and subsequent conditional LTM, the following items can be considered for the configuration of execution condition:
   The CLTM configuration of each candidate cell shall include the execution condition for initial conditional LTM, which is generated by the initial source cell to trigger the CLTM for the candidate cell.
   The CLTM configuration of each candidate cell may include execution conditions for subsequent conditional LTM, which is generated by the candidate cell to trigger the CLTM for other candidate cells when the candidate cell becomes a serving cell.
6. The network can configure measurement reports e.g., L1 periodic, semi-persistent, aperiodic and event triggered report, or L3 measurement reports for conditional LTM, e.g., to trigger PDCCH ordered early RACH.
7. For CLTM, the Candidate Cell TCI States Activation/Deactivation MAC CE is re-used for the early activation/deactivation of TCI state(s) of a CLTM candidate configuration.
8. The Early TA is signalled to the UE from the source cell (i.e., not from the candidate cell directly to the UE). This agreement will be included in the LS to RAN1/3/4.
9. The network can inform the candidate cell's TA information to UE via new MAC CE, which is the TA value when UE switches to that candidate cell during CLTM.
10. Candidate cell TA is maintained by a new timer.
11. For L1-based conditional LTM the condition evaluation is at MAC level and for L3-based conditional LTM the condition evaluation is at RRC level.

In running MAC CR for supporting enhanced mobility Ph4 ([3] R2-2502158 Running MAC CR for Mob Ph4), L1 measurement and event triggered report and conditional LTM are introduced:

### 5.x L1 Measurement and Event Triggered Report

Editor's NOTE: Whether/How to guarantee the hominization between LTM and MIMO is FFS. Rapporteur will coordinate with MIMO MAC rapporteur on this, if MIMO agreed to capture the event-based measurement in MAC.

### 5.x.1 Introduction

Editor's NOTE: The description for introduction part needs to be updated if CLTM related parts is agreed to be captured in this clause.

The network may configure an RRC_CONNECTED UE to perform L1 [FFSbeam level] measurements for LTM candidate cell(s), including L1 RSRP [and SINR]. The network may configure the UE to report them in accordance with the L1 event triggered beam level measurement configuration. The measurement report is used for indicating to serving gNB of the L1 beam level measurement results from the serving cell and/or candidate cell(s) when an L1 event trigger condition is satisfied. The measurement configuration is provided by means of RRC dedicated signalling.
Editor's NOTE: Beam quantity of SINR is up to RAN1 discussion and decision. Similar for events definition. By now, the conclusion in RAN1 is: there is no consensus in RAN1 on the support L1-SINR measurement based on CSI-RS for candidate cells.

The network may configure the UE to perform L1 event triggered beam level measurement for the following LTM purpose:
Select the candidate beam and cell for early synchronization;
Select the target beam and cell for an LTM cell switch procedure.
Editor's NOTE: The description for the LTM purpose above needs to be further refined after more progress.

The network may configure the UE to report the following measurement information based on SS/PBCH block(s):
Measurement results per SS/PBCH block;
SS/PBCH block(s) resource indicator (SSBRI).

The network may configure the UE to report the following measurement information based on CSI-RS resources:
Measurement results per CSI-RS resource;
CSI-RS resource indicator (CRI).

The RRC configures the following parameters in [the LTM-CSI-ReportConfig and LTM-CSI-ResourceConfig] for L1 event triggered measurement and corresponding report procedure:
[RRCParameter for measurement configuration]: [To be updated].
[RRCParameter for report configuration]: [To be updated].
Editor's NOTE: The corresponding RRC parameters description will be updated later to be aligned with RRC specification.

### 5.x.2 Performing Measurement

An RRC_CONNECTED UE obtains L1 beam level measurement results by measuring one or multiple beams as configured by the network as specified in [RAN1 REF]. For each L1 beam level measurement result in RRC_CONNECTED, the UE applies the layer 1 filtering by implementation, before using the measured results for evaluation of reporting criteria and measurement reporting.

The MAC entity performs the evaluation of reporting criteria as specified in 5.x.3 based on the L1 filtered measurement results from lower layer.

For L1 beam level event triggered measurements report, the network can configure SS/PBCH block(s) or CSI-RS as event evaluation RS type, and L1-RSRP [or SINR] as trigger quantity. Reporting quantities is the same as the trigger quantity.

### 5.x.3 Measurement Report Triggering

### 5.x.3.1 General

Editor's NOTE: The structure for this clause could be further discussed/updated based on companies' view. There are two methods to capture this part. Method #1: for each reportID (associated with event), report is triggered if any beam (associated with this reportID) fulfils the event by evaluating all beams during TTT for each beam. Method #2: for each beam, report is triggered if any event (from the event associated with this beam) associated with reportID fulfils the event by evaluating all corresponding events during TTT associated each event. Method #1 is adopted as below. Companies are invited to provide views on which method is preferred.

The UE maintains the following UE variables for L1 event triggered measurement and report procedure:
MR_LIST: includes the L1 event triggered measurement report information, for which the L1 measurement report triggering conditions have been met;
MR_SENT_COUNTER: represents the number of L1 event triggered measurement report performed by UE if the triggering condition for the corresponding event is met for each Itm-CSI-ReportConfigId;
BEAM_TRIGGERED_LIST: includes the reference signaling resource index of LTM candidate cell(s) for each Itm-CSI-ReportConfigId, for which the L1 measurement report triggering conditions have been met.

Unless explicitly specified otherwise, it is up to UE implementation how to store these variables.

The MAC entity shall for the serving cell configured for LTM event evaluation procedure:
[1> for each Itm-CSI-ReportConfigId of the serving cell included in the LTM-CSI-ReportConfig:]
Editor's NOTE: There is no conclusion whether to introduce a measID-like parameter or use the reportID. This part will be further updated based on progress.
   2> if the corresponding Itm-ReportConfigType is set to eventTriggered:
   3> if the eventLTM2 is configured in the corresponding Itm-CSI-ReportConfigId:
      4> consider only the current beam of serving cell, i.e. the beam corresponds to the RS configured in the indicated TCI State or the RS QCLed with the RS configured in the indicated TCI State indicated by TCI State in the serving cell [as defined in clause 5.1.5 in TS 38.214], to be applicable;
   3> if the eventLTM3 or eventLTM5 is configured in the corresponding Itm-CSI-ReportConfigId:
      4> consider any beam of LTM candidate cell configured in LTM-CSI-ResourceConfig which associated with this Itm-CSI-ReportConfigId to be applicable;
   3> if the eventLTM4 is configured in the corresponding Itm-CSI-ReportConfigId:
      4> consider any beam of LTM candidate cell configured in LTM-CSI-ResourceConfig which associated with this ltm-CSI-ReportConfigId, to be appliable;
   2> if the entry condition for the event associated with Itm-CSI-ReportConfigId is fulfilled for one or more applicable beams, i.e. reference signalling associated with LTM-CSI-SSB-ResourceConfigId or LTM-CSI-RS-ResourceConfigId in the LTM-CSI-ReportConfig, for the measurement from lower layer during timeToTrigger defined for this event:
   3> if the MR_LIST does not include a measurement reporting entry for this ltm-CSI-ReportConfigId (a first beam triggers the event):
      4> include a measurement reporting entry in the MR_LIST for this Itm-CSI-ReportConfigId;
   3> include the SSBRI or CRI of the concerned beam(s) in the BEAM_TRIGGERED_LIST for this Itm-CSI-ReportConfigId;
   3> if reportAmount is configured in the LTM-EventTriggeredPeriodicReport by RRC:
      4> set the MR_SENT_COUNTER to 0 for this Itm-CSI-ReportConfigId and reference signaling resource index;
   3> initiate the measurement reporting procedure, as specified in 5.x.4.
   2> else if the leaving condition for the event associated with Itm-CSI-ReportConfigId is fulfilled for one or more applicable beams included in the MR_LIST for the measurement from lower layer during timeToTrigger defined for this event:
   3> remove the concerned beam(s) in the MR_LIST for this Itm-CSI-ReportConfigId;
   3> if reportOnLeave is set to true for this Itm-CSI-ReportConfigId:
      4> initiate the measurement reporting procedure, as specified in 5.x.4;
   3> if the BEAM_TRIGGERED_LIST for this Itm-CSI-ReportConfigId is empty:
      4> remove the measurement reporting entry within the MR_LIST for this Itm-CSI-ReportConfigId;
   2> upon expiry of the periodical reporting timer for this Itm-CSI-ReportConfigId:
   3> initiate the measurement reporting procedure, as specified in 5.x.4.
NOTE x: timeToTrigger is not restarted if the current beam of serving cell changes and the entry condition is still met with the new current beam.
NOTE y: To evaluate the L1 measurement reporting triggering event, the UE uses the latest filtered L1-RSRP [or L1-SINR] measurement from lower layer.

### 5.x.3.2 Event LTM2 (Beam of Serving Cell Becomes Worse than Threshold)

The UE shall:
1> consider the entering condition for this event to be satisfied when condition LTM2-1, as specified below, is fulfilled;
1> consider the leaving condition for this event to be satisfied when condition LTM2-2, as specified below, is fulfilled;
1> for this measurement, consider the current beam, i.e. corresponding to the RS configured in the indicated TCI state or the RS QCLed with the RS configured in the indicated TCI state in the serving cell [as defined in clause 5.1.5 in TS 38.214, associated with this event.
Editor's NOTE: The indicated TCI state in RAN1 could be indicated by RRC, or configured by RRC and indicated by MAC CR or DCI. The wording could be further updated based on the discussion.

### Inequality LTM2-1 (Entering Condition)

Ms−Hys>Thresh

### Inequality LTM2-2 (Leaving Condition)

Ms+Hys<Thresh

The variables in the formula are defined as follows:
Ms is the beam measurement quantity of the serving cell based on SS/PBCH block or CSI-RS, not taking into account any offsets. The beam associated with this event is the current beam, i.e. corresponding to the RS configure in the indicated TCI state or the RS QCLed with the RS configured in the indicated TCI state in the serving cell [as defined in clause 5.1.5 in TS 38.214].
Hys is the hysteresis parameter for this event (i.e. [hysteresis] as defined within [TBD RRC parameter] for this event).
Thresh is the threshold parameter for this event (i.e. [Itm2-Threshold] as defined within [TBD RRC parameter] for this event).
Ms is expressed in dBm in case of RSRP, [or in dB in case of SINR].
Hys is expressed in dB.
Thresh is expressed in the same unit as Ms.
Editor's NOTE: The corresponding RRC parameters is to be aligned with RRC specification. Similar as other events.

### 5.x.3.3 Event LTM3 (Beam of Candidate Cell Becomes Offset Better than Beam of Serving Cell)

The UE shall:
1> consider the entering condition for this event to be satisfied when condition LTM3-1, as specified below, is fulfilled;
1> consider the leaving condition for this event to be satisfied when condition LTM3-2, as specified below, is fulfilled;
1> for this measurement, consider the current beam, i.e. corresponding to the RS configured in the indicated TCI state or the RS QCLed with the RS configured in the indicated TCI state in the serving cell [as defined in clause 5.1.5 in TS 38.214, with the same RS type as the beam of candidate cell, associated with this event.

### Inequality LTM3-1 (Entering Condition)

Mn+Obn−Hys>Ms+Obs+Off

### Inequality LTM3-2 (Leaving Condition)

Mn+Obn+Hys<Ms+Obs+Off

The variables in the formula are defined as follows:
Mn is the beam measurement quantity of the LTM candidate cell based on SS/PBCH block or CSI-RS, not taking into account any offsets.
Obn is the [FFS RS type specific] offset of the beam of the LTM candidate cell (i.e. [beamIndividualOffsetN] as defined in [TBD RRC parameter] for this event).
Ms is the beam measurement quantity of the serving cell based on SS/PBCH block or CSI-RS, not taking into account any offsets. The beam associated with this event is the current beam, i.e corresponding to the RS configured in the indicated TCI state or the RS QCLed with the RS configured in the indicated TCI State indicated by TCI State in the serving cell [as defined in clause 5.1.5 in TS 38.214] in the serving cell.
Obs is the [FFS RS type specific] offset of the beam of the serving cell (i.e. [beamIndividualOffsetS] as defined in [TBD RRC parameter] for this event).
Editor's NOTE: Whether the beam specific offset Obn and Obs is RS type specific is FFS. Similar as other events.
Hys is the hysteresis parameter for this event (i.e. [hysteresis] as defined within [TBD RRC parameter] for this event).
Off is the offset parameter for this event (i.e. [Itm3-Offset] as defined within [TBD RRC parameter] for this event).
Mn, Ms are expressed in dBm in case of RSRP, [or in dB in case of SINR].
Obn, Obs, Hys, Off are expressed in dB.

### 5.x.3.4 Event LTM4 (Beam of Candidate Cell Becomes Better than Absolute Threshold)

The UE shall:
1> consider the entering condition for this event to be satisfied when condition LTM4-1, as specified below, is fulfilled;
1> consider the leaving condition for this event to be satisfied when condition LTM4-2, as specified below, is fulfilled.

### Inequality LTM4-1 (Entering Condition)

Mn+Obn−Hys>Thresh

### Inequality LTM4-2 (Leaving Condition)

Mn+Obn+Hys<Thresh

The variables in the formula are defined as follows:
Mn is the beam measurement quantity of the LTM candidate cell based on SS/PBCH block or CSI-RS, not taking into account any offsets.
Obn is the [FFS RS type specific] offset of the beam of the LTM candidate cell (i.e. [beamIndividualOffsetN] as defined in [TBD RRC parameter] for this event).
Hys is the hysteresis parameter for this event (i.e. [hysteresis] as defined within [TBD RRC parameter] for this event).
Off is the offset parameter for this event (i.e. [Itm3-Offset] as defined within [TBD RRC parameter] for this event).
Mn is expressed in dBm in case of RSRP, [or in dB in case of SINR].
Obn, Hys are expressed in dB.
Thresh is expressed in the same unit as Mn.

### 5.x.3.5 Event LTM5 (Beam of Serving Cell Becomes Worse than Threshold1 and Beam of Candidate Cell Becomes Better than Threshold2)

The UE shall:
1> consider the entering condition for this event to be satisfied when both condition LTM5-1 and condition LTM5-2, as specified below, are fulfilled;
1> consider the leaving condition for this event to be satisfied when condition LTM5-3 or condition LTM5-4, i.e. at least one of the two, as specified below, is fulfilled;

### Inequality LTM5-1 (Entering Condition 1)

Ms+Hys<Thresh1

### Inequality LTM5-2 (Entering Condition 2)

Mn+Obn−Hys>Thresh2

### Inequality LTM5-3 (Leaving Condition 1)

Ms−Hys>Thresh1

### Inequality LTM5-4 (Leaving Condition 2)

Mn+Obn+Hys<Thresh2

The variables in the formula are defined as follows:
Ms is the beam measurement quantity of the serving cell based on SS/PBCH block or CSI-RS, not taking into account any offsets. The beam associated with this event is the current beam, i.e corresponding to the RS configured in the indicated TCI state or the RS QCLed with the RS configured in the indicated TCI State indicated by TCI State in the serving cell [as defined in clause 5.1.5 in TS 38.214] in the serving cell.
Mn is the beam measurement quantity of the LTM candidate cell based on SS/PBCH block or CSI-RS, not taking into account any offsets.
Obn is the RS type specific offset of the beam of the LTM candidate cell (i.e. [beamIndividualOffsetN] as defined in [TBD RRC parameter] for this event).
Hys is the hysteresis parameter for this event (i.e. [hysteresis] as defined within [TBD RRC parameter] for this event).
Thresh1 is the threshold parameter for this event (i.e. [ltm5−Threshold1] as defined within [TBD RRC parameter] for this event).
Thresh2 is the threshold parameter for this event (i.e. [ltm5−Threshold2] as defined within [TBD RRC parameter] for this event).
Mn, Ms are expressed in dBm in case of RSRP, [or in dB in case of SINR].
Obn, Hys are expressed in dB.
Thresh1 is expressed in the same unit as Ms.
Thresh2 is expressed in the same unit as Mn.

### 5.x.4 Measurement Report

The purpose of this procedure is to transfer L1 measurement results from the UE to the network.

RRC controls the L1 event triggered beam level measurement reporting by configuring the following parameter:
[RRCParameter]: [To be updated].
Editor's NOTE: The corresponding RRC parameters description will be updated later to be aligned with RRC specification.

For the L1 event triggered measurement reporting, the MAC entity shall:
1> if at least one L1 measurement report has been triggered as specified in 5.x.3 [and not cancelled]:
   2> if UL-SCH resources are available for a new transmission in the serving cell and these UL-SCH resources can accommodate the L1 measurement report MAC CE plus its subheader as a result of logical channel prioritization:
   3> instruct the Multiplexing and Assembly procedure to generate the L1 measurement report MAC CE;
   3> increment the MR_SENT_COUNTER associated with the Itm-CSI-ReportConfigId for the RS signal triggered the report by 1;
   3> stop the periodical reporting timer, if running;
   3> if reportAmount is configured in RRC, and the MR_SENT_COUNTER as defined for this ltm-CSI-ReportConfigId is less than reportAmount:
      Proposal 1 4> start the periodical reporting timer with the value of reportInterval for this Itm-CSI-ReportConfigId as defined within the corresponding LTM-CSI-reportConfig;
   2> else if the UL-SCH resources are available for a new transmission in the serving cell and these UL-SCH resources can accommodate the Truncated L1 measurement report MAC CE plus its subheader as a result of logical channel prioritization:
   3> instruct the Multiplexing and Assembly procedure to generate the Truncated L1 measurement report MAC CE;
   3> increment the MR_SENT_COUNTER associated with the Itm-CSI-ReportConfigId for the RS signal triggered the report by 1;
   3> stop the periodical reporting timer, if running;
   3> if reportAmount is configured in RRC, and the MR_SENT_COUNTER as defined for this Itm-CSI-ReportConfigId is less than reportAmount:
      Proposal 2 4> start the periodical reporting timer with the value of reportInterval for this Itm-CSI-ReportConfigId as defined within the corresponding LTM-CSI-reportConfig;
   2> else:
   3> if the dedicated SR configuration for L1 measurement report MAC CE transmission is configured:
      Proposal 3 4> trigger the SR using the dedicated SR configuration for L1 measurement report;
   3> else:
      Proposal 4 4> trigger the SR using the SR configuration for L1 measurement report.
Editor's NOTE: Whether/How to introduce padding L1 measurement report will be updated based on the progress in RAN2, if any.

### 5.y Conditional LTM

Editor's NOTE: The cross layer operation for CLTM, i.e. interaction/information exchange between RRC and MAC, needs to be further updated based on discussion progress and the description in RRC specification.

### 5.y.1 Introduction

The network may configure an RRC_CONNECTED UE to perform L1 beam level measurements for SpCell and conditional LTM candidate cell(s), including L1 RSRP [and SINR]. The UE may use the L1 measurement for LTM cell switch conditions evaluation in accordance with the reconfiguration for conditional LTM. The network may configure the UE to report the L1 measurement results for conditional LTM, e.g., to trigger PDCCH ordered early RACH or early TCI state activation.
Editor's NOTE: This part will be updated after more progress and considering the corresponding description in RRC.

The RRC configures the following parameters in [the CLTM-ExecutionConditions] for L1 trigger condition for CLTM procedure:
[RRCParameter for CLTM execution condition]: [To be updated].
Editor's NOTE: The corresponding RRC parameters description will be updated later to be aligned with RRC specification.

### 5.y.2 Conditional LTM Triggering Condition Evaluation

[Upon indication from upper layers to initiate the LTM cell switch conditions evaluation based on L1 measurements according to the indicated field cltm-ServingCellExecutionConditions,] the MAC entity shall for the Pcell configured for conditional LTM procedure:
1> for each entry within the CLTM-ExecutionConditions:
   2> if the LTM3 or LTM5 is configured in the corresponding Itm-CSI-ReportConfigId for 11-Conditions:
   3> consider all beams of LTM candidate cell indicated by the Itm-CandidateId within this CLTM-ExecutionConditions to be applicable;
   3> if the entry condition for the event associated with Itm-CSI-ReportConfigId is fulfilled for one or more applicable beams, i.e. reference signalling associated with LTM-CSI-SSB-ResourceConfigId or LTM-CSI-RS-ResourceConfigId in the LTM-CSI-ReportConfig, for the measurement from lower layer during timeToTrigger defined for this event;
      Proposal 5 4> consider the event associated with LTM-CSI-ReportConfigId to be fulfilled for the ltm-CandidateId associated with LTM-CSI-ReportConfigId;
      Proposal 6 4> perform the CLTM execution procedure for the LTM candidate configuration associated with Itm-CandidateId according to the procedure specified in 5.y.3;

### 5.y.3 Conditional LTM Execution

The conditional LTM cell switch procedure is triggered when:
the MAC entity determines that the event for conditional LTM is satisfied based on L1 measurements as specified in clause 5.y.2;
the event for conditional LTM is satisfied based on L3 measurements indicated by upper layers.
Editor's NOTE: This part is needed for some operation in other clause, e.g. in clause 5.2. It could be further updated or may be removed in case it is clear for MAC (and RRC).

The MAC entity shall:
1> if the MAC entity determines that the event for conditional LTM is satisfied based on L1 measurements as specified in clause 5.y.2:
   2> indicate to upper layers that the event for conditional LTM is satisfied based on L1 measurements [or the LTM cell switch procedure is triggered], and the Target Configuration ID, corresponding to Itm-CandidateId minus 1, for which the associated L1 measurement based event is satisfied.
NOTE X: When multiple candidate beams satisfy the event for conditional LTM, it is up to UE implementation to select a beam and perform C-LTM.
Editor's NOTE: FFS on the modelling for interaction between RRC layer and MAC layer.
[FFS 1> if the MAC reset operation as specified in clause 5.12 is performed, as requested by upper layers:
   Upon indication on the Target Configuration ID from upper layers, if any, for the satisfied L3 measurement based event;
   2> if the Itm-Candidate-TimeAlignmentTimer associated with the Target Configuration ID is running in the first available CG occasion for initial CG transmission according to clause 5.8.2:
   3> process the stored Timing Advance Command associated with the Itm-Candidate-TimeAlignmentTimer (see clause 5.2x);
   3> consider the RACH-less LTM cell switch to be ongoing;]
   [FFS 2> else if the UE is configured with UE-based Timing Advance measurement as specified in TS 38.331 [5] and the UE has successfully measured the Timing Advance for the SpCell of the LTM target configuration in the first available CG occasion for initial CG transmission according to clause 5.8.2:
   3> process the measured Timing Advance (see clause 5.2x);
   3> consider the RACH-less LTM cell switch to be ongoing;]
   > [FFS 2> if cg-RRC-Configuration is configured and the RACH-less LTM cell switch is considered to be ongoing:
   3> attempt to select a configured uplink grant for initial uplink transmission according to clause 5.8.2;
   3> if a valid configured uplink grant is selected:]
      Proposal 7 4> perform initial uplink transmission in the first available CG occasion for RACH-less handover according to clause 5.8.2;
4> monitor the PDCCH as specified in clause 5.7 and TS 38.213 [6] Editor's NOTE: FFS on the condition to use the CG-based RACH-less CLTM.
Editor's NOTE: FFS on whether the received CLTM TAs of other candidate cells is released or still valid at UE side upon CLTM execution.

### 6.1.3.x Event Triggered L1 Measurement Report MAC CE

Event triggered L1 measurement report MAC CE consists of either:
event triggered L1 measurement report format (variable size); or
truncated event triggered L1 measurement report format (variable size).

The event triggered L1 measurement report formats are identified by MAC subheaders with an eLCIDs as specified in Table 6.2.1-2b.

For truncated event triggered L1 measurement report MAC CE, report ID field and at least one beam with corresponding measurement quantity are included.

The fields in the (truncated) event triggered L1 measurement report MAC CE are defined as follows:
Editor's NOTE: The detailed field(s) and corresponding description will be further updated based on the discussion progress.
Editor's NOTE: Explicit indication in MR MAC CE to inform which beam(s) meets the event condition with TTT. FFS on the detailed signalling.
Editor's NOTE: Explicit indication in MR MAC CE to inform the leaving event condition is met. FFS whether it is per beam.
   Report ID: This field indicates corresponding measurement report ID for this Itm-CSI-ReportConfigId associated with this event triggered measurement report. The length of the Report ID field is 6 bits;
   [TBD Satisfied Quantity: This field indicates the number of beams which fulfil the trigger event in the event triggered L1 measurement report. The maximum number of Satisfied Quantity is [x]. The network controls if the beam(s) not satisfying the event could not be reported. Accordingly, this field should be absent;]
   RSRIᵢ: This field indicates the reference signaling resource index of the beam i for the event triggered L1 measurement report (i.e. SS/PBCH Block Resource indicator (SSBRI) or CSI-RS resource indicator (CRI)). The maximum number of non-serving beams reported is configured by maxNumberOfReportedBeams. [If the network configures the UE could report the measurement results of the beams not fulfilling the trigger event by [reportMaxNumOfBeams], the first beam(s) with the number of Satisfied Quantity are the beam(s) fulfil the trigger event.] The length of the RSRI index field is 9 bits;
   [DiffMRᵢ or DiffRSRPᵢ]: This field indicates the derived differential measurement quantity based on SS/PBCH block or CSI-RS (i.e. the L1-RSRP or SINR) for the beam i of LTM candidate cell as described in TS 38.215 [24]. The length of the [DiffMR or DiffRSRP] field is 4 bits;
   [MR_{serving} or RSRP_{serving}]: This field indicates the derived measurement quantity based on SS/PBCH block or CSI-RS (i.e. the L1-RSRP or SINR) for current beam of serving cell as described in TS 38.215 [24], if UE is configured to report the measurement result of current beam of the serving cell by reportCurrentBeam. [The length of the [MR or RSRP] field is 7 bits];
   R: Reserved bit, set to 0.

In running RRC CR for mobility ([4] R2-2502096 introduction of event-triggered meas report for RRC), configuration for beam reporting is introduced:
LTM-CSI-ReportConfig

The IE LTM-CSI-ReportConfig is used to configure gNB-scheduled measurement report on the cell in which the LTM-CSI-ReportConfig is included when the field ltm-ReportConfigType is configured as periodic/semi-persistentOnPUCCH/semi-persistentOnPUSCH/aperiodic.

The IE LTM-CSI-ReportConfig is also used to configure event-triggered measurement report when the field Itm-ReportConfigType is configured as eventTriggered, within which the criteria for triggering measurement report by MAC CE as in TS 38.321 [3] is specified.
Event LTM2: Beam of SpCell becomes worse than absolute threshold;
Event LTM3: Beam of candidate cell becomes amount of offset better than the beam of SpCell;
Event LTM4: Beam of candidate cell becomes better than absolute threshold;
Event LTM5: Beam of SpCell becomes worse than absolute threshold1 AND Beam of candidate cell becomes better than another absolute threshold2.

LTM-CSI-ReportConfig information element

| -- ASN1START | |
|---|---|
| -- TAG-LTM-CSI-REPORTCONFIG-START | |
| LTM-CSI-ReportConfig-r18 ::= SEQUENCE { | |
| ltm-CSI-ReportConfigId-r18 | LTM-CSI-ReportConfigId-r18, |
| ltm-Resources ForChannelMeasurement-r18 | LTM-CSI-ResourceConfigId-r18, |
| ltm-ReportConfigType-r18 | CHOICE { |
| periodic-r18 | SEQUENCE { |
| reportSlotConfig-r18 | CSI-Report PeriodicityAndOffset, |
| pucch-CSI-ResourceList-r18 | SEQUENCE (SIZE (1..maxNrofBWPs ) ) OF |
| PUCCH-CSI-Resource | |
| }, | |
| semi PersistentOnPUCCH-r18 | SEQUENCE { |
| reportSlotConfig-r18 | CSI-Report PeriodicityAndOffset, |
| pucch-CSI-ResourceList-r18 | SEQUENCE (SIZE (1..maxNrofBWPs ) ) OF |
| PUCCH-CSI-Resource | |
| }, | |
| semiPersistentOnPUSCH-r18 | SEQUENCE { |
| reportSlotConfig-r18 | CSI-Report PeriodicityAndOffset, |
| reportSlotOffsetList-r18 | SEQUENCE (SIZE (1.. maxNrofUL- |
| Allocations-r16) ) OF INTEGER (0..128), | |
| reportSlotOffsetListDCI-0-2-r18 | SEQUENCE (SIZE (1.. maxNrofUL- |
| Allocations-r16) ) OF INTEGER (0..128), | |
| reportSlotOffsetListDCI-0-1-r18 | SEQUENCE (SIZE (1.. maxNrofUL- |
| Allocations-r16) ) OF INTEGER (0..128), | |
| p0alpha | P0-PUSCH-AlphaSetId |
| }, | |
| aperiodic-r18 | SEQUENCE { |
| reportSlotOffsetList-r18 | SEQUENCE (SIZE (1.. maxNrofUL- |
| Allocations-r16) ) OF INTEGER (0..128), | |
| reportSlotOffsetListDCI-0-2-r18 | SEQUENCE (SIZE (1.. maxNrofUL- |
| Allocations-r16) ) OF INTEGER (0..128), | |
| reportSlotOffsetListDCI-0-1-r18 | SEQUENCE (SIZE (1.. maxNrofUL- |
| Allocations-r16) ) OF INTEGER (0..128) | |
| }, | |
| ..., | |
| eventTriggered-r19 | SEQUENCE { |
| eventId-r19 | CHOICE { |
| eventLTM2-r19 | SEQUENCE { |
| ltm2-Threshold-r19 | MeasTriggerQuantity, |
| hysteresis-r19 | Hysteresis, |
| timeToTrigger-r19 | TimeToTrigger, |
| eventEvaluationRS-Type-r19 | ENUMERATED {csi-rs, ssb} |
| OPTIONAL, -- Need R | |
| ... | |
| }, | |
| eventLTM3-r19 | SEQUENCE { |
| ltm3-Offset-r19 | MeasTriggerQuantityOffset, |
| hysteresis-r19 | Hysteresis, |
| timeToTrigger-r19 | TimeToTrigger, |
| ... | |
| }, | |
| eventLTM4-r19 | SEQUENCE { |
| ltm4-Threshold-r19 | MeasTriggerQuantity, |
| hysteresis-r19 | Hysteresis, |
| timeToTrigger-r19 | TimeToTrigger, |
| ... | |
| }, | |
| eventLTM5-r19 | SEQUENCE { |
| ltm5-Threshold1-r19 | MeasTriggerQuantity, |
| ltm5-Threshold2-r19 | MeasTriggerQuantity, |
| hysteresis-r19 | Hysteresis, |
| timeToTrigger-r19 | TimeToTrigger, |
| ... | |
| }, | |
| ... | |
| -- Editor's NOTE: FFS the event evaluation RS Type for LTM2 in RAN1 dicsussion. | |
| }, | |
| ltm-EventTriggeredReportContent-r19 | LTM- |
| EventTriggeredReportContent-r19, | |
| reportOnLeave-r19 | ENUMERATED {enabled, disabled} |
| OPTIONAL, -- Need R | |
| ltm-EventTriggeredPeriodicReport-r19 | LTM- |

EventTriggeredPeriodicReport-r19 OPTIONAL, -- Need S ...

| } | |
|---|---|
| }, | |
| ltm-ReportContent-r18 | LTM-ReportContent-r18, |
| ...} | |
| LTM-ReportContent-r18 ::= SEQUENCE { | |
| nrOfReportedCells-r18 | ENUMERATED {n1, n2, n3, n4} , |
| nrOfReportedRS-PerCell-r18 | ENUMERATED {n1, n2, n3, n4}, |
| spCellInclusion-r18 | ENUMERATED {true} |
| OPTIONAL -- Need R | |
| } | |
| LTM-EventTriggeredPeriodicReport-r19 ::= SEQUENCE { | |
| reportInterval-r19 | Report Interval, |
| reportAmount-r19 | ENUMERATED {r2, r4, r8, r16, r32, r64, infinity, |
| spare1}, | |
| ... | |
| } | |
| LTM-EventTriggeredReportContent-r19 ::= | SEQUENCE { |
| maxNumberOfReportedBeams-r19 | INTEGER (1..256), |
| allowReportAnyBeam-r19 | ENUMERATED {enabled, disabled}, |
| reportCurrentBeam-r19 | ENUMERATED {enabled, disabled}, |
| ... | |

-- Editor's NOTE: FFS exact value of the maximum beams that can be reported. Current value set as a

placeholder for ASN1 compilation.
-- Editor's NOTE: FFS additional values on the report intervals
}
-- TAG-LTM-CSI-REPORTCONFIG-STOP
-- ASN1STOP

[1] LTM-CSI-ReportConfig field descriptions

[2] eventEvaluationRS-Type
[3] Indicates the type of reference signal for LTM event evaluation. csi-rs corresponds to QCL RS of the indicated
joint/DL TCI state; and ssb corresponds to SSB QCLed with the QCL RS of the indicated joint/DL TCI state.
[4] eventId
[5] Type of LTM event for triggering event-triggered measurement report as specified in TS 38.321 [3].
hysteresis
Hysteresis when evaluating the entering/leaving conditions for an LTM event.
ltm-EventTriggeredPeriodicReport
This field indicates when an LTM event is triggered, whether the event-triggered measurement report is sent
periodically. When the field is absent, the event-triggered measurement report is sent once, as specified in TS 38.321
[3].
ltm-ReportConfigType
This field specifies how the UE shall report the measurement results for LTM either by gNB-scheduled measurement
report or by event-triggered measurement report by MAC CE.
ltm-ReportContent
This field defines the content of the LTM L1 measurement report. When the ltm-ReportConfigType is set to
event Triggered, this field shall be ignored.
ltm-ResourcesForChannelMeasurement
This field indicates the index of SSB or CSI-RS in the field LTM-CSI-ResourceConfig. When ltm-ReportConfigType is
set to EventTriggered, and eventId is configured as eventLTM2, this field shall be ignored.
ltm2-Threshold, ltm4-Threshold, ltm5-Threshold1, ltm5-Threshold2
Thresholds defined in the entering/leaving conditions for different LTM events.
ltm3-Offset
Offset for the entering/leaving condition for event LTM3. The actual value is field value * 0.5 dB.
reportOnLeave
Indicates whether the event-triggered measurement report by MAC CE shall be triggered when leaving condition is
satisfied, as specified in TS 38.321 [3].
reportSlotConfig
Periodicity and slot offset (see TS 38.214 [19], clause 5.2.1.4).
reportSlotOffsetList, reportSlotOffsetListDCI-0-1, reportSlotOffsetListDCI-0-2
Timing offset Y for semi persistent reporting using PUSCH and aperiodic reporting.
timeToTrigger
Time during which an entering/leaving condition needs to be consistently satisfied for triggering event-triggered
measurement report by MAC CE as specified in TS 38.321 [3].

LTM-ReportContent field descriptions

nrOfReportedCells
This field defines how many cells are reported within a single L1 measurement report instance.
nrOfReportedRS-PerCell
This field defines how many RSs per cell are reported within a single L1 measurement report instance.
spCellInclusion
This field indicates whether the UE shall include a L1 measurement report associated to the current SpCell. This field can only be
configured if the current SpCell is configured as an SpCell of an LTM candidate configuration and the LTM-CSI-ResourceConfig IE
associated to the LTM-CSI-ReportConfig IE includes resources for the current SpCell.

LTM- EventTriggeredReportContent field descriptions

allowReportAnyBeam
Indicates whether the UE shall report the measurement results for the beams not satisfying the conditions of the events as specified
in TS 38.321 [3].
maxNumberOfReportedBeams
This field defines number of beams whose measurements can be reported in the event-triggered measurement report by MAC CE as
specified in TS 38.321 [3]. This number of beams does not include the measurement of the current beam on SpCell if they are
configured to be reported.
reportCurrentBeam
Indicates whether the UE shall report the measurement result of the current beam as specified in TS 38.321 [3].

LTM-EventTriggeredPeriodicReport field descriptions

reportInterval
This field defines the periodicity of the event-triggered periodic measurement report.
reportAmount
Number of measurement reports needs to be transmitted after the event is triggered as specified in TS 38.321 [3]. Value ′r2′ means
the report is sent twice, ’r3’ means the report is sent three times, and so on.

### LTM-CSI-ResourceConfig

The IE LTM-CSI-ResourceConfig defines a group of one or more CSI resources for one or more LTM candidate configurations

LTM-CSI-ReportConfig information element

| -- ASN1START | | |
|---|---|---|
| -- TAG-LTM-CSI-RESOURCECONFIG-START | | |
| LTM-CSI-ResourceConfig-r18 ::= | SEQUENCE { | |
| ltm-CSI-ResourceConfigId-r18 | LTM-CSI-ResourceConfigId-r18, | |
| ltm-SSB-ResourceSet-r18 | LTM-SSB-ResourceSet-r18, | |
| ... , | | |
| [[ | | |
| ltm-CSI-RS-ResourceSet-r19 | LTM-CSI-RS-ResourceSet-r19 | OPTIONAL -- |
| Need R | SEQUENCE { | |
| ]] | | |
| } | | |
| LTM-SSB-ResourceSet-r18 ::= | SEQUENCE { | |
| ltm-SSB-ResourceList-r18 | SEQUENCE (SIZE (1..maxNrofLTM-CSI-ResourcesPerSet-r18)) OF SSB- | |
| Index, | | |
| ltm-CandidateIdList-r18 | SEQUENCE (SIZE (1..maxNrofLTM-CSI-ResourcesPerSet-r18) ) OF | |
| LTM-CandidateId-r18, | | |
| ... | | |
| } | | |
| LTM-CSI-RS-ResourceSet-r19 : := | SEQUENCE { | |
| ltm-CSI-RS-ResourceList-r19 | SEQUENCE (SIZE (1..maxNrofLTM-CSI-ResourcesPerSet-r19) ) OF | |
| NZP-CSI-RS-ResourceId, | | |
| ltm-CandidateIdList-r19 | SEQUENCE (SIZE (1..maxNrofLTM-CSI-ResourcesPerSet-r19) ) OF | |
| LTM-CandidateId-r18, | | |
| ... | | |
| } | | |

-- Editor's NOTE: FFS: how to associate between the measurement CSI-RS resources and candidate
cells. explicit or implicit signaling of candidate cells per RAN1's agreement. Current change
following the legacy SSB configuration serves as a placeholder with a explicit candidate cell's ID.
-- TAG-LTM-CSI-RESOURCECONFIG-STOP
-- ASN1STOP

LTM-CSI -ResourceConfig field descriptions

ltm-SSB-ResourceSet
This field indicates the resource set for LTM measurement based on SSB.
ltm-CSI-RS-ResourceSet
This field indicates the resource set for LTM measuremenet based on CSI-RS. When the field is present, the UE shall ignore the
field ltm-SSB-ResourceSet.
Editor's NOTE: FFS whether it is possible to configure CSI-RS without SSB and wait for R1's progress.

LTM-SSB-ResourceSet field descriptions

ltm-CandidateIdList
This field indicates the LTM candidate configuration IDs related to the SSBs in the ltm-SSB-ResourceList. The list has the same
number of entries as ltm-SSB-ResourceList. The first entry in this list shall be associated to the first entry in ltm-SSB-ResourceList,
the second entry of this list shall be associated to the second entry in ltm-SSB-ResourceList, and so on.
ltm-SSB-ResourceList
This field is used to indicate on SS/PBCH block resources from one or more LTM candidate cells.

LTM-CSI-RS-ResourceSet field descriptions

ltm-CandidateIdList
This field indicates the LTM candidate configuration IDs related to the SSBs in the ltm-CSI-RS-ResourceList. The list has the same
number of entries as ltm-CSI-RS-ResourceList. The first entry in this list shall be associated to the first entry in ltm-CSI-RS-
ResourceList, the second entry of this list shall be associated to the second entry in ltm-CSI-RS-ResourceList, and so on.
ltm-CSI-RS-ResourceList
This field is used to indicate on NZP CSI-RS resources from one or more LTM candidate cells. If the resource type of the NZP-CSI-
RS resource is semi-persistent, the ltm-ReportConfigType within LTM-CSI-ReportConfig that this resource set is associated with
cannot be configured as eventTriggered.

In RAN2#129bis ([5] 3GPP RAN2#129bis meeting report), agreements have been made regarding mobility enhancements:
Introducing a new R19 LTM cell switch command MAC CE with indicating the NCC value for R19 inter-CU LTM cell switch. Details will be further discussed during CR phase.
For differential L1-RSRP reporting, the best quality beam among the beams included in L1 MR MAC CE is taken as the reference beam as the first one. The differential L1-RSRP value is derived based on the absolute L1-RSRP of the reference beam. FFS for truncated MAC CE.
When UL grant is enough to accommodate only limited number of beams in MR MAC CE, the triggered beam should be included in the truncated MR MAC CE.
When current beam is configured to be included in the L1 MR MAC CE, 7 bits of RSRP is included and no RSRI is needed.
The current beam information of SpCell (if configured to be included) is always placed at the end of the normal (not truncated) MAC CE.
Same as Rel-18: When the C-LTM execution is triggered, if the TA of the target cell acquired by early RACH is valid, UE applies the TA acquired by early RACH, otherwise if UE has successfully measured the TA of the target cell, UE applies the measured TA.
FFS For MR triggered by LTM2, whether only include the current beam information in the MR MAC CE or the MR can include measurements for LTM candidates.

### Agreements on L1 Event-Triggered MR

1. Introduce new MAC CE to activate/deactivate the semi-persistent CSI-RS resource.
2. The new MAC CE includes: A/D indication, Target configuration id or {SP CSI-RS resource set id and/or candidate id}, TCI state id.
3. In L1 reporting configuration, the UE can be configured with a list of candidate IDs. For each listed candidate ID, the network can configure an offset, this offset applies to all the RSS belong the candidate ID that associated with the reporting configuration (the offset value also includes 0 dB); If a candidate ID is not provided in the reporting configuration, it means the UE is not required to measure/evaluate the RSs that belonging to the candidate ID for this event, even if these are configured within the L1 resource configuration (to which the L1 reporting configuration points to).
4. In the MR MAC CE, adopt a uniform format for all the reported beams (i.e., using the same format for beams leaving the entering condition, beams met the entering condition, beams not satisfying the event). Introduce two bits per beam.
5. RAN2 will consider only the following options:
   Option1: To introduce four codepoints to represent one of {type1, type2, type3, type4}
   Option3: To introduce three codepoints to represent one of {type1_or_type3, type2, type4}, i.e., type1 beam and type3 beam are not distinguished in reporting.
   Type1 beam: a beam that has satisfied the entry condition of the event for TTT and thus triggers the MR MAC CE.
   Type2 beam: a beam that has satisfied the leaving condition of the event for TTT and thus triggers the MR MAC CE.
   Type3 beam: a beam that is neither type1 nor type2 but has remained in beamsTriggeredList (the beam was reported as type1 beam before).
   Type4 beam: a beam that is neither type1 nor type2 and not included in beamsTriggeredList (i.e., just extra beam info)
6. Working assumption: Option1: To introduce four codepoints to represent one of {type1, type2, type3, type4}
7. Intention is that the UE should be able to report the event-triggered beam(s) that were not included in the truncated MR MAC CE by the following grant. Detailed wording can be further discussed as part of the running CR.
8. For co-existence with mTRP, will be revisited in August. If one simple solution is not prepared/agreed until/in August meeting, we will not apply mTRP in Rel-19 event-triggered MR.

In Release 18 New Radio (NR), Layer 1 (L1)/Layer 2 (L2)-triggered mobility (LTM) procedure is introduced. A User Equipment (UE) could be configured with candidate cell configuration(s) by a network (NW) indicating one or more candidate cells for LTM Cell switch. The UE could be triggered by an NW via a Medium Access Control (MAC) Control Element (CE) (LTM Cell Switch Command MAC CE) to perform an (LTM) Cell switch. An LTM procedure could be a Random Access Channel (RACH)-based (Contention-Based Random Access (CBRA) or Contention-Free Random Access (CFRA)) or a RACH-less LTM procedure. The UE could determine whether to perform a RACH-less LTM procedure based on at least whether there is a valid Timing Advance (TA) for a target candidate cell of the LTM procedure. A UE could be configured with configured uplink grant (e.g., configured grant Type 1) for transmitting message(s) (e.g., Radio Resource Control (RRC) reconfiguration complete message or LTM complete message) to the target candidate cell in a RACH-less LTM procedure to the target candidate cell. Alternatively, the UE could be provided with a dynamic uplink grant (from the target candidate cell) for transmission of the message(s). A valid TA could be provided by the network (e.g., via an LTM Cell switch Command MAC CE) or measured by the UE (itself). A candidate Cell could be associated with a Timing Advance Group (TAG) for time alignment. A candidate Cell could be associated with or could include multiple TAs that are associated with different Transmission and Reception Points (TRPs). The candidate Cell could be associated with more than one Timing Advance group (TAG). In Rel-18, the UE considers a configured uplink grant for RACH-less LTM switch as valid when Synchronization Signal Block (SSB) corresponding to the configured uplink grant has the same SSB index as an SSB associated with a Transmission Configuration Indicator (TCI) state indicated by a TCI state Identity/Identification (ID) field in LTM Cell Switch Command MAC CE.

In Rel-19 mobility enhancement, event-triggered L1 measurement report (or UE-initiated beam reporting) is introduced for the UE to perform measurement reporting for Serving Cells and/or candidate cells. The UE could be configured with a report configuration (e.g., event triggered LTM-Channel State Information (CSI)-ReportConfig) associated with one or more candidate cells. The report configuration could be associated with an event (e.g., event LTM2, LTM3, LTM4, or LTM 5). The UE could trigger an event-triggered L1 measurement report (or trigger a UE-Initiated (UEI) reporting for LTM) if or when an (applicable) beam associated with the report configuration fulfills the event or entering condition associated with the report configuration. Additionally and/or alternatively in certain embodiments, the UE could trigger an event-triggered L1 measurement report if or when an (applicable) beam fulfills a leaving condition associated with the report configuration. The UE could be configured with more than one report configuration, each could be associated with a same or different event and/or candidate cell.

A UE could transmit a MAC CE for reporting an event triggered L1 measurement report (associated with a report configuration). The MAC CE could contain at least one of:
a report configuration id,
one or more triggered beams (fulfilling entering condition),
one or more triggered beams (fulfilling leaving condition),
one or more beams that do not meet or fulfill an event,
one or more beams that do not meet or fulfill an event and are in a list (e.g., BEAM_TRIGGERED_LIST or MR_LIST), and/or
(differential) Reference Signal Received Power (RSRP) and/or Received Signal Strength Indicator (RSSI) associated with a reported beam.

A trigger beam could be a beam that fulfills or meets an entering or leaving condition associated with a report configuration.

For a report configuration, a UE could be configured with a maximum number of beams to report in one beam report (e.g., in one event triggered L1 Measurement Report (MR) MAC CE). For example, the max number could be maxNumberOfReportedBeam (e.g., 2, 4, or 8, or a fixed value). An issue could occur when the UE instructs a Multiplexing and Assembly procedure to generate an L1 measurement report MAC CE, for a limited number of beams to report in the MAC CE, how a UE selects which beams to report is ambiguous. Another issue could occur in reporting of a truncated MR MAC CE. When an Uplink (UL) grant is not enough to accommodate a complete event triggered L1 MR MAC CE, the UE will have to select a number of beams (among different kinds of beams). In the present invention, methods and solutions are introduced regarding beam selection for UE-initiated beam reporting and/or for an event-triggered measurement report for mobility enhancements.
Candidate Beam selection for MR MAC CEs, including selection of beams for complete and truncated MR MAC CEs.
(Truncated) MAC CE can only contain 3 beams.
   e.g., 1-prioritize select triggered beam to be put, then the order is based on quality.
   e.g., 2-select: prioritize quality, order: based on quality; or based on first quality->triggered beam->others quality.
   e.g., 3-selecting one best beam first, and then prioritizing triggered beam, and then base on quality of other beams. Order: based on quality or based on triggered beam or based on first quality->triggered beam->others quality.

If total triggered beam>n: based on quality/beam id/entering>leaving.
can best beam be current beam? What happens if best beam is one of the triggered beam(s).
e.g., x-cyclic (enter, leaving, enter leaving).
e.g., y-based on candidate cell (distribute between cells).

One concept of the present invention is that in response to a triggered or initiated event-triggered measurement reporting (procedure) associated with a report configuration, a UE could determine whether to include and/or select a first one or more beams among one or more (or all) beams associated with the report configuration in a beam report based on at least one of one or more features associated with the first one or more beams.

The one or more features could include a type of a beam (e.g., Type1 beam, Type2 beam, Type3 beam, and/or Type4 beam).

The one or more features could include a quality of a beam (e.g., RSRP).

The one or more features could include a condition associated with the report configuration fulfilled by the beam (e.g., entering or leaving condition).

The one or more features could include an index associated with the beam (e.g., Synchronization Signal Block Resource Indicator (SSBRI) or CSI Signal Resource Indicator (CRI)).

The one or more features could include a Cell associated with the beam (e.g., Serving Cell or candidate cell).

### Beam Selection/Inclusion: Best Quality->Triggered Beam->Others

For example, in response to initiated or triggered measurement reporting, the UE could prioritize including/selecting the first one or more beam(s) to include in the beam report (e.g., (complete or truncated) Event triggered L1 Measurement Report MAC CE) based on at least quality of the first one or more beam(s). In one example, the UE could prioritize selecting/including n beams with best quality among all (configured beams or associated) beams of the report configuration, wherein n could be the (maximum) number of beams to be reported to the network for the report configuration.

In another example, for a first beam to be included in the beam report, the UE could prioritize selecting/including a best beam associated with a report configuration. For the rest of the beams to be included (e.g., n−1 beams) in the beam report, the UE could prioritize selecting/including triggered beam(s) associated with an initiated measurement reporting of the report configuration. The UE may not include beam(s) that are not triggered beams nor the best beam before including the triggered beam(s) and/or the best beam in the beam report. The beam(s) that are neither triggered beam(s) nor the best beam could be referred to as other beam(s). Additionally and/or alternatively in certain embodiments, the beam(s) that does not trigger a measurement reporting (or a measurement report MAC CE) could be referred to as other beam(s).

Additionally and/or alternatively in certain embodiments, the UE could prioritize including triggered beam(s) based on quality (e.g., RSRP). Alternatively, the UE could prioritize selecting/including triggered beam(s) based on a index or id associated with the beams (e.g., the UE could prioritize selecting/including triggered beams with a smaller id or index (e.g., SSBRI, CRI, SSB index or LTM-CSI-RS-ResourceConfigId or LTM-CSI-SSB-ResourceConfigId)).

Additionally and/or alternatively in certain embodiments, the UE could prioritize including the other beam(s) based on quality (e.g., RSRP or RSSI). Alternatively, the UE could prioritize selecting/including other beam(s) based on an index or id associated with the beams (e.g., the UE could prioritize selecting/including other beams with a smaller id or index (e.g., SSRBI, CRI, SSB index or LTM-CSI-RS-ResourceConfigId or LTM-CSI-SSB-ResourceConfigId)). Additionally and/or alternatively in certain embodiments, the UE could prioritize including beam(s) of the other beam(s) based on whether the beam(s) are included in

BEAM_TRIGGERED_LIST (e.g., or based on whether the beam(s) has been reported or was reported in previous beam report(s)). For example, when including the other beam(s), the UE could prioritize including a first other beam that has been reported in a previous beam report over a second other beam that has not been reported in a previous beam report. For example, the UE could prioritize selecting/including beam(s) that are included in BEAM_TRIGGERED_LIST over beam(s) that are not included in BEAM_TRIGGERED_LIST.

Alternatively, the UE could prioritize selecting/including beam(s) that are not included in BEAM_TRIGGERED_LIST over beam(s) that are included in BEAM_TRIGGERED_LIST. The BEAM_TRIGGERED_LIST could be a beam list containing beam(s) that have been reported (as type1 beam) in a previous beam report (and/or has not fulfill a leaving condition).

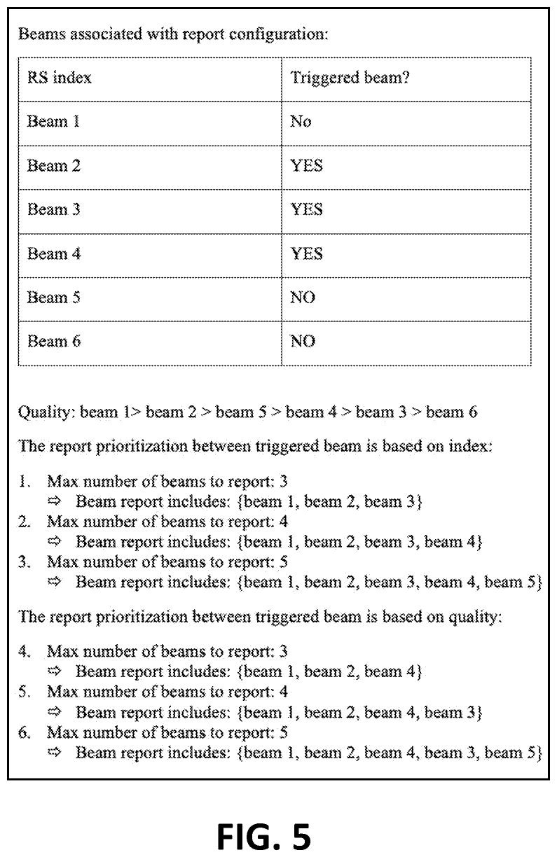

An example is shown FIG. 5. The UE could be configured with 6 beams, Beam 1 to Beam 6, for a report configuration for event triggered measurement reporting. The UE could initiate or trigger measurement reporting in response to at least one of the beams (e.g., Beam 2, 3, and 4, which are triggered beams) fulfills a condition associated with the report configuration. When determining which beams to include in the beam report, the UE could first determine to include/select the best beam (beam with highest quality) and include beam 1 (it may or may not be a triggered beam). For other beams to report, the UE could first prioritize including triggered beams. Among triggered beams, the UE could prioritize selecting/including beams based on quality or based on the index/id associated with the triggered beams. If all triggered beams are included, the UE could include other beams in the beam report.

### Prioritize Triggered Beam

In another example, the UE could prioritize including triggered beam(s) associated with the report configuration (e.g., regardless of quality of beams). The UE may not include/select non-triggered beams (other beams) into the beam report before all triggered beams are selected/included into the beam report. The UE could include one beam of the triggered beam(s) that has the highest priority at the first octet or at the first beam position in the beam report. Alternatively, the UE could place one highest-quality beam (regardless of the type of the beam) at the first entry of beam(s) in the beam report.

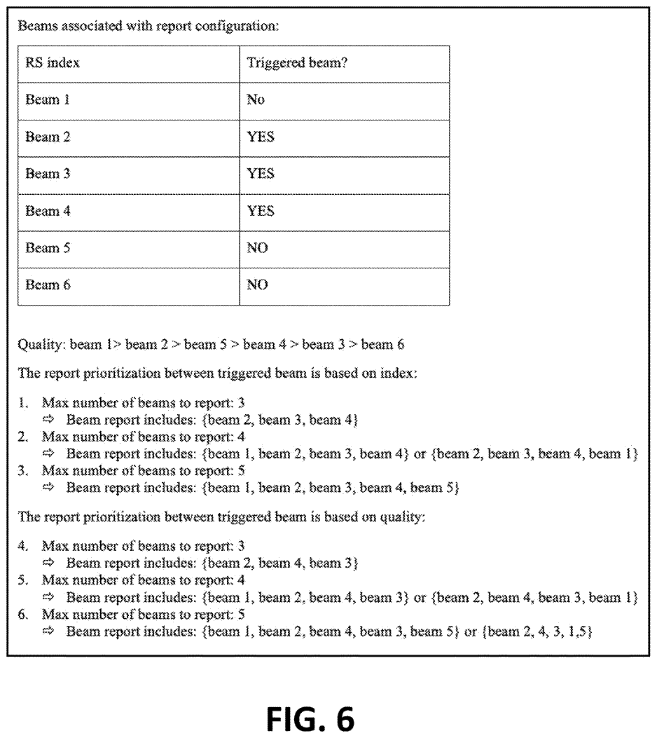

Another example is shown in FIG. 6. When prioritizing triggered beams first, the UE could include triggered beams first (beam 2 to 4) before including other beams.

Prioritize entering/leaving conditions

Additionally and/or alternatively in certain embodiments, the UE could prioritize including/selecting triggered beam(s) that fulfills the entering condition over triggered beam(s) that fulfills the leaving condition of the report configuration. The UE may not include/selected triggered beam(s) fulfilling the leaving condition before (all) triggered beams fulfilling the entering condition are included/selected. Among triggered beams fulfilling the entering condition, the UE could prioritize including/selecting triggered beams associated with higher quality. Among triggered beams fulfilling the leaving condition, the UE could prioritize including/selecting triggered beams associated with higher quality.

### Cyclic

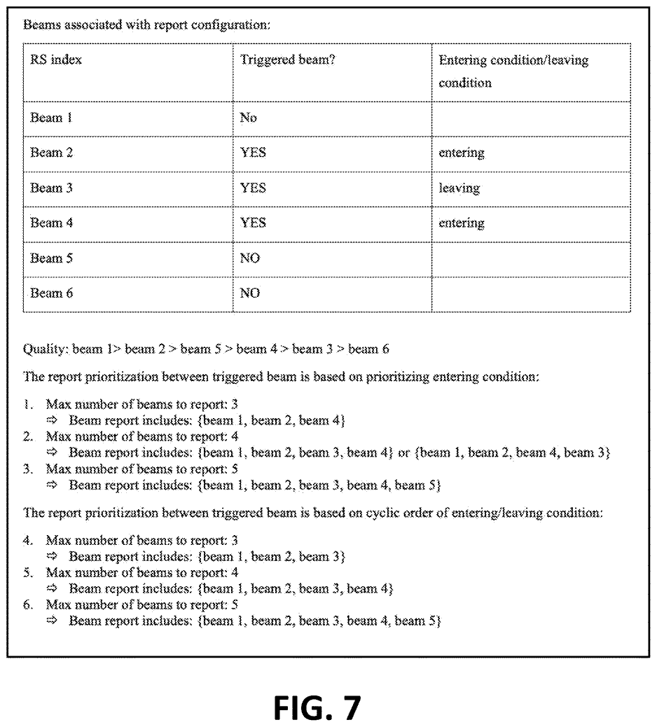

Additionally and/or alternatively in certain embodiments, the UE could include/select between triggered beam(s) fulfilling the entering condition and triggered beam(s) fulfilling the leaving condition in a cyclic manner. For example, the UE could first prioritize including a first triggered beam fulfilling the entering condition, and then prioritizing including a second triggered beam fulfilling the leaving condition, and then includes a third triggered beam fulfilling the entering condition, and so on. An example is shown in FIG. 7.

### Prioritize Cells

Additionally and/or alternatively in certain embodiments, the UE could prioritize including/selecting a beam (triggered beam, other beam, etc.) that is associated with a Cell that does not have a corresponding beam included in the beam report. The UE could prioritize selecting/including beam(s) in the beam report to report the most Cells possible. The UE could maximize the number of Cells (e.g., among Cells that has triggered beam and/or among Cells that has the highest quality beams) of which information are to be reported in the beam report.

The prioritizing could be determination of whether or not to include information of the beam(s) in the beam report.

### Order of the MAC CE

Additionally and/or alternatively in certain embodiments, when determining an order of selected/included beam(s) the UE could prioritize placing beam(s) based on the index or id associated with the beams (e.g., the UE could select/include triggered beams with the smallest id or index (e.g., SSRBI, CRI, SSB index or LTM-CSI-RS-ResourceConfigId or LTM-CSI-SSB-ResourceConfigId)).

Additionally and/or alternatively in certain embodiments, when determining an order of selected/included beam(s) in the beam report, the UE could prioritize placing beam(s) based on quality associated with the beams.

Additionally and/or alternatively in certain embodiments, when determining an order of selected/included triggered beam(s) in the beam report, the UE could prioritize placing beam(s) based on index/id, and/or quality associated with the beams.

Additionally and/or alternatively in certain embodiments, when determining an order of selected/included triggered beam(s) in the beam report, the UE could prioritize placing beam(s) based on the entering/leaving condition associated with the beams (e.g., entering condition-fulfilled beams are placed before the leaving condition-fulfilled beams).

The prioritizing could be determining the place and/or order of the beam(s) to be set/placed in the beam report.

The prioritization of order of beams in a beam report could have different methods with the prioritization of selection or inclusion of beams into a beam report.

### Truncated MAC CE

Additionally and/or alternatively in certain embodiments, when a UL grant cannot accommodate a (complete) beam report MAC CE, the UE could include/generate a truncated beam report (e.g., truncated Event triggered L1 measurement report MAC CE).

For a truncated beam report, the UE could prioritize including/selecting a (single) triggered beam before including/selecting other beams. The other beam(s) could be beam(s) that are not triggered beam(s).

The UE could prioritize selecting/including a triggered beam fulfilling the entering condition into the truncated beam report (e.g., prioritize including a triggered beam fulfilling entering condition over a triggered fulfilling the leaving condition into the truncated beam report).

The UE could prioritize selecting/including a triggered beam fulfilling the leaving condition into the truncated beam report.

The UE could prioritize selecting/including a triggered beam with the smallest index/id among all (triggered) beams into the truncated beam report.

The UE could prioritize selecting/including a triggered beam with highest quality (e.g., RSRP) into the truncated beam report.

Additionally and/or alternatively in certain embodiments, the UE could prioritize including/selecting other beam (that does not fulfill any condition and is not a best beam) over a triggered beam (fulfilling the leaving condition) into a truncated beam report.

Additionally and/or alternatively in certain embodiments, the UE could (first) prioritize selecting/including a best beam (among all applicable beams of the report configuration) (before selecting/including a triggered beam of the report configuration).

Additionally and/or alternatively in certain embodiments, the UE could (first) prioritize selecting/including beam information for the most Cells (possible) to be reported in a (truncated) beam report.

Additionally and/or alternatively in certain embodiments, the UE could have a same or different prioritization method for selecting/including beam information in a beam report and selecting/including beam information in a truncated beam report.

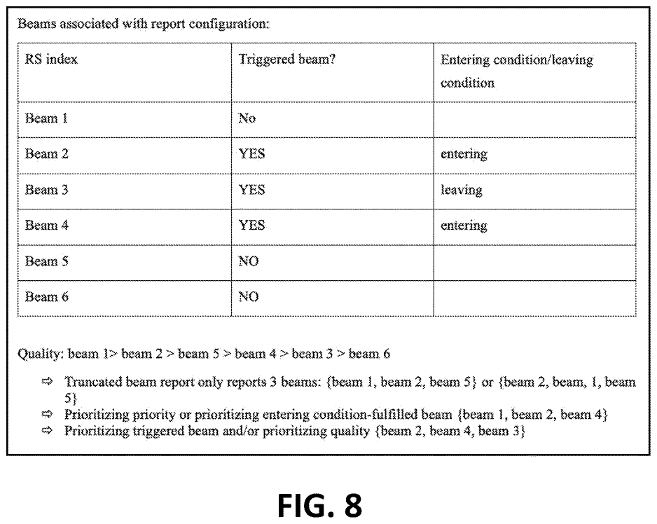

An example is shown in FIG. 8. For a truncated beam report, the UE could prioritize selecting one triggered beam to report (e.g., best quality triggered beam) and select other beams based on quality (e.g., beam 2 is first selected, and then beam 1 and beam5 are selected based on quality). Alternatively, the UE could prioritize selecting a best beam (e.g., beam 1) and then prioritize including/selecting a triggered beam (e.g., entering condition-fulfilled beam, beam 2 and beam 4). Alternatively, the triggered beam selection could be based on selection of an entering/triggering condition in a cyclic manner (e.g., first beam 2, then beam 3, then beam 4). Additionally and/or alternatively in certain embodiments, the triggered beam selection could be based on prioritizing selecting a beam satisfying entering condition over a beam satisfying leaving condition.

For the methods, alternatives, concepts, examples, and embodiments detailed above and herein, the following aspects and embodiments are possible. A total number of beams of the first one or more beams could be configured by a network.

The report configuration could be LTM-CSI-ReportConfig. The report configuration could be associated with initiation of a (event-triggered) measurement report. The report configuration could be associated with transmission and generation of the beam report.

The first one or more beams could be a part of (the second one or more) beams of which SSB-index are configured in Itm-SSB-ResourceSet of the report configuration. The first one or more beams could be associated with LTM-CSI-RS-ResourceConfigId or LTM-CSI-SSB-ResourceConfigId in the LTM-CSI-ReportConfig associated with the report configuration. The first one or more beams could be a part of beams associated with one or more candidate cells associated with the report configuration. The (first and/or second one or more) beams could be applicable beams associated with the report configuration.

A best beam of a report configuration could be a beam associated with a highest quality (when a measurement reporting procedure is initiated or triggered) among all beams associated with (or configured in) a report configuration.

Additionally and/or alternatively in certain embodiments, a best beam of a report configuration could be a beam that triggered or initiated a measurement reporting procedure of the report configuration. Additionally and/or alternatively in certain embodiments, a best beam of the report configuration may not be a beam that triggered the measurement reporting.

A triggered beam of a report configuration could be a beam fulfilling an event condition associated with the report configuration (for a time duration timetotrigger/Time-To-Trigger (TTT)). The condition could be an entering (or entry) condition or a leaving condition of the report configuration.

The Type1 beam of a report configuration could be a beam that has satisfied an entry condition of the report configuration for TTT and/or triggers a measurement report MAC CE and/or triggers a measurement reporting.

The Type2 beam of a report configuration could be a beam that has satisfied a leaving condition for TTT of the report configuration and/or triggers a measurement report MAC CE and/or triggers a measurement reporting.

The Type3 beam of a report configuration could be a beam that was reported as a type 1 beam before.

The Type3 beam of a report configuration could be a beam not associated with a triggered measurement reporting associated with the report configuration.

The Type3 beam of a report configuration could be a beam that does not fulfill an entry and/or a leaving condition of the report configuration.

The Type3 beam of a report configuration could be a beam that was reported (as a Type1 beam) in a previous beam report.

The Type3 beam of a report configuration could be a beam included in a list for beams that were reported.

The Type4 beam of a report configuration could be a beam that fulfills neither an entry nor leaving condition and was not reported in a previous beam report.

The beam report could be a (truncated) event triggered L1 Measurement Report MAC CE.

Alternatively, the beam report could be a (complete or full) event triggered L1 Measurement Report MAC CE. A beam could be a reference signal, an SSB, a CSI-RS, and/or associated with an SRS resource set.

An entry condition could be an entering condition.

Any combination of the above or herein concepts or teachings can be jointly combined, in whole or in part, or formed to a new embodiment. The disclosed details and embodiments can be used to solve at least (but not limited to) the issues mentioned above and herein.

For the methods, alternatives, concepts, examples, and embodiments detailed above and herein, the following aspects and embodiments are possible.

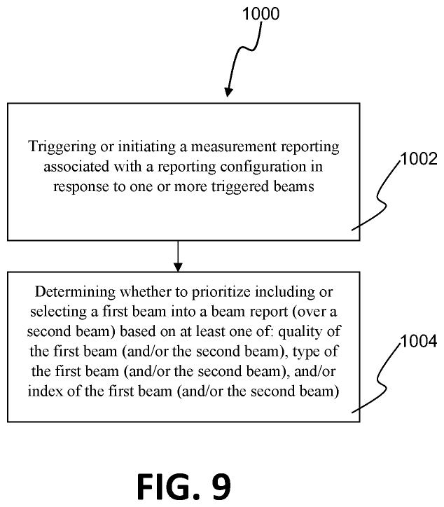

Referring to FIG. 9, with this and other concepts, systems, and methods of the present invention, a method 1000 for a UE in a wireless communication system comprises triggering or initiating a measurement reporting associated with a reporting configuration in response to one or more triggered beams (step 1002), and determining whether to prioritize including or selecting a first beam into a beam report (over a second beam) based on at least one of: quality of the first beam (and/or the second beam), type of the first beam (and/or the second beam), and/or index of the first beam (and/or the second beam) (step 1004).

In various embodiments, the UE selects the first beam over all other beams associated with the report configuration if or when the first beam is a best beam associated with the reporting configuration.

In various embodiments, the best beam is a beam associated with a highest quality among beams of the report configuration.

In various embodiments, the report configuration is LTM-CSI-ReportConfig.

In various embodiments, the UE prioritizes including the first beam over the second beam if or when the first beam is a triggered beam and the second beam is not a triggered beam.

In various embodiments, the type of the first beam is a triggered beam fulfilling an entering condition. In various embodiments, the type of the first beam is a triggered beam fulfilling a leaving condition. In various embodiments, the type of the first beam is a best beam.

In various embodiments, the type of the first beam is another/other beam.

In various embodiments, the another/other beam is a beam that is not a best beam and is not a beam fulfilling any condition associated with the report configuration.

In various embodiments, the UE does not prioritize the first beam over the second beam if or when the first beam is a triggered beam fulfilling a leaving condition and the second beam is another/other beam.

Referring back to FIGS. 3 and 4, in one or more embodiments from the perspective of a device (e.g., UE) in a wireless communication system, the device 300 includes a program code 312 stored in memory 310 of the transmitter. The CPU 308 could execute program code 312 to: (i) trigger or initiate a measurement reporting associated with a reporting configuration in response to one or more triggered beams; and (ii) determine whether to prioritize including or selecting a first beam into a beam report (over a second beam) based on at least one of: quality of the first beam (and/or the second beam), type of the first beam (and/or the second beam), and/or index of the first beam (and/or the second beam). Moreover, the CPU 308 can execute the program code 312 to perform all of the described actions, steps, and methods described above, below, or otherwise herein.

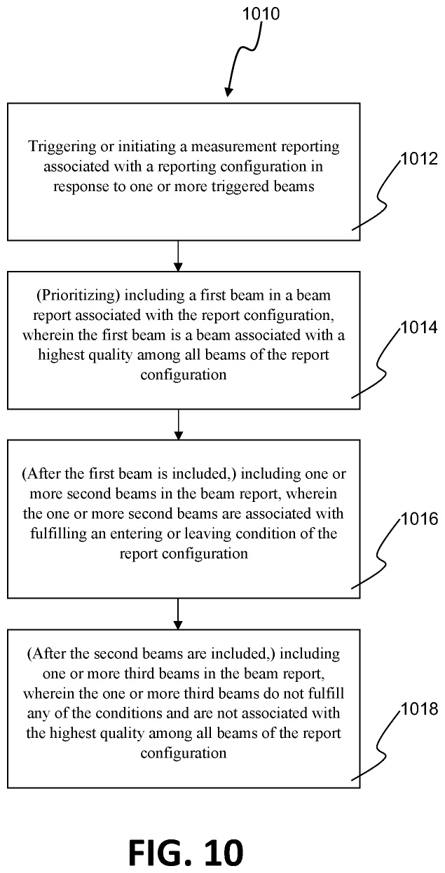

Referring to FIG. 10, with this and other concepts, systems, and methods of the present invention, a method 1010 for a UE in a wireless communication system comprises triggering or initiating a measurement reporting associated with a reporting configuration in response to one or more triggered beams (step 1012), (prioritizing) including a first beam in a beam report associated with the report configuration, wherein the first beam is a beam associated with a highest quality among all beams of the report configuration (step 1014), (after the first beam is included), including one or more second beams in the beam report, wherein the one or more second beams are associated with fulfilling an entering or leaving condition of the report configuration (step 1016), and (after the second beams are included) including one or more third beams in the beam report, wherein the one or more third beams do not fulfill any of the conditions and are not associated with the highest quality among all beams of the report configuration (step 1018).

In various embodiments, the beam report is a (truncated) Event Triggered L1 Measurement Report MAC CE.

Referring back to FIGS. 3 and 4, in one or more embodiments from the perspective of a device (e.g., UE) in a wireless communication system, the device 300 includes a program code 312 stored in memory 310 of the transmitter. The CPU 308 could execute program code 312 to: (i) trigger or initiate a measurement reporting associated with a reporting configuration in response to one or more triggered beams; (ii) (prioritize) include a first beam in a beam report associated with the report configuration, wherein the first beam is a beam associated with a highest quality among all beams of the report configuration; (iii) (after the first beam is included), include one or more second beams in the beam report, wherein the one or more second beams are associated with fulfilling an entering or leaving condition of the report configuration; and (iv) (after the second beams are included) include one or more third beams in the beam report, wherein the one or more third beams do not fulfill any of the conditions and are not associated with the highest quality among all beams of the report configuration. Moreover, the CPU 308 can execute the program code 312 to perform all of the described actions, steps, and methods described above, below, or otherwise herein.

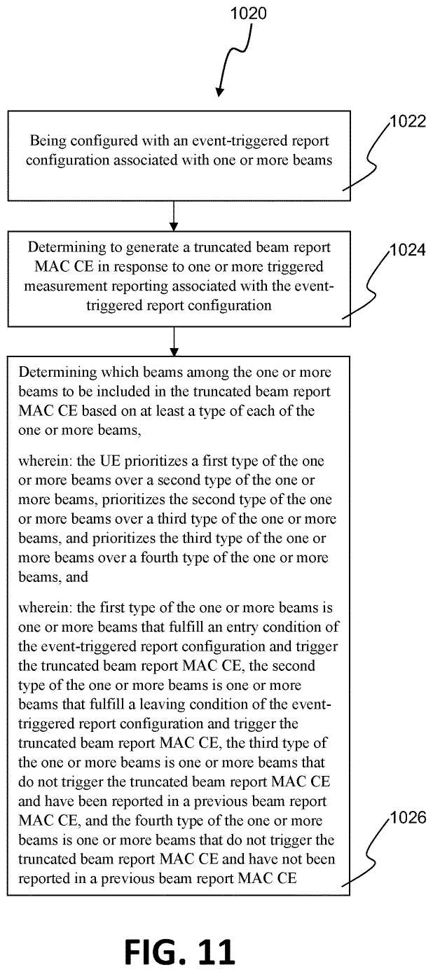

Referring to FIG. 11, with this and other concepts, systems, and methods of the present invention, a method 1020 for a UE in a wireless communication system comprises being configured with an event-triggered report configuration associated with one or more beams (step 1022), determining to generate a truncated beam report MAC CE in response to one or more triggered measurement reporting associated with the event-triggered report configuration (step 1024), and determining which beams among the one or more beams to be included in the truncated beam report MAC CE based on at least a type of each of the one or more beams, wherein: the UE prioritizes a first type of the one or more beams over a second type of the one or more beams, prioritizes the second type of the one or more beams over a third type of the one or more beams, and prioritizes the third type of the one or more beams over a fourth type of the one or more beams, and wherein: the first type of the one or more beams is one or more beams that fulfill an entry condition of the event-triggered report configuration and trigger the truncated beam report MAC CE, the second type of the one or more beams is one or more beams that fulfill a leaving condition of the event-triggered report configuration and trigger the truncated beam report MAC CE, the third type of the one or more beams is one or more beams that do not trigger the truncated beam report MAC CE and have been reported in a previous beam report MAC CE, and the fourth type of the one or more beams is one or more beams that do not trigger the truncated beam report MAC CE and have not been reported in a previous beam report MAC CE (step 1026).

In various embodiments, the UE determines to generate the truncated beam report MAC CE in response to the one or more triggered measurement reporting based on at least an UL-SCH resource available for a new transmission cannot accommodate a complete beam report MAC CE.

In various embodiments, the complete beam report MAC CE is an event triggered L1 measurement report MAC CE.

In various embodiments, the event-triggered report configuration is LTM-CSI-ReportConfig. 1n various embodiments, the truncated beam report MAC CE is a truncated event triggered L1 measurement report MAC CE.

In various embodiments, the third type of the one or more beams does not fulfill an entry condition and/or a leaving condition of the event-triggered report configuration, and/or the third type of the one or more beams is included in a list containing one or more beams that were reported in a previous beam report MAC CE, and/or the third type of the one or more beams is not associated with the one or more triggered measurement reporting.

In various embodiments, the UE prioritizes including a first beam of the first type of the one or more beams over a second beam of the first type of the one or more beams in the truncated beam report MAC CE based on quality of the first beam being higher than quality of the second beam.

In various embodiments, the first type of the one or more beams fulfills the entry condition by satisfying the entry condition for TTT, and the second type of the one or more beams fulfills the leaving condition by satisfying the leaving condition for TTT.

In various embodiments, the UE triggers the one or more triggered measurement reporting in response to the first type of the one or more beams fulfilling the entry condition and/or the second type of the one or more beams fulfilling the leaving condition.

In various embodiments, the one or more beams are one or more applicable beams of the event-triggered report configuration.

Referring back to FIGS. 3 and 4, in one or more embodiments from the perspective of a device (e.g., UE) in a wireless communication system, the device 300 includes a program code 312 stored in memory 310 of the transmitter. The CPU 308 could execute program code 312 to: (i) be configured with an event-triggered report configuration associated with one or more beams; (ii) determine to generate a truncated beam report MAC CE in response to one or more triggered measurement reporting associated with the event-triggered report configuration; and (iii) determine which beams among the one or more beams to be included in the truncated beam report MAC CE based on at least a type of each of the one or more beams, wherein: the UE prioritizes a first type of the one or more beams over a second type of the one or more beams, prioritizes the second type of the one or more beams over a third type of the one or more beams, and prioritizes the third type of the one or more beams over a fourth type of the one or more beams, and wherein: the first type of the one or more beams is one or more beams that fulfill an entry condition of the event-triggered report configuration and trigger the truncated beam report MAC CE, the second type of the one or more beams is one or more beams that fulfill a leaving condition of the event-triggered report configuration and trigger the truncated beam report MAC CE, the third type of the one or more beams is one or more beams that do not trigger the truncated beam report MAC CE and have been reported in a previous beam report MAC CE, and the fourth type of the one or more beams is one or more beams that do not trigger the truncated beam report MAC CE and have not been reported in a previous beam report MAC CE. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
being configured with an event-triggered report configuration associated with one or more beams;
determining to generate a truncated beam report Medium Access Control (MAC) Control Element (CE) in response to one or more triggered measurement reporting associated with the event-triggered report configuration; and
determining which beams among the one or more beams to be included in the truncated beam report MAC CE based on at least a type of each of the one or more beams, wherein: the UE prioritizes a first type of the one or more beams over a second type of the one or more beams, prioritizes the second type of the one or more beams over a third type of the one or more beams, and prioritizes the third type of the one or more beams over a fourth type of the one or more beams, and wherein: the first type of the one or more beams is one or more beams that fulfill an entry condition of the event-triggered report configuration and trigger the truncated beam report MAC CE, the second type of the one or more beams is one or more beams that fulfill a leaving condition of the event-triggered report configuration and trigger the truncated beam report MAC CE, the third type of the one or more beams is one or more beams that do not trigger the truncated beam report MAC CE and have been reported in a previous beam report MAC CE, and the fourth type of the one or more beams is one or more beams that do not trigger the truncated beam report MAC CE and have not been reported in a previous beam report MAC CE.

2. The method of claim 1, wherein the UE determines to generate the truncated beam report MAC CE in response to the one or more triggered measurement reporting based on at least an Uplink (UL)-Shared Channel (SCH) resource available for a new transmission cannot accommodate a complete beam report MAC CE.

3. The method of claim 2, wherein the complete beam report MAC CE is an event triggered Layer 1 (L1) measurement report MAC CE.

4. The method of claim 1, wherein the event-triggered report configuration is L1/Layer 2 (L2) Triggered Mobility (LTM)-Channel State Information (CSI)-ReportConfig.

5. The method of claim 1, wherein the truncated beam report MAC CE is a truncated event triggered L1 measurement report MAC CE.

6. The method of claim 1, wherein the third type of the one or more beams does not fulfill an entry condition and/or a leaving condition of the event-triggered report configuration, and/or the third type of the one or more beams is included in a list containing one or more beams that were reported in a previous beam report MAC CE, and/or the third type of the one or more beams is not associated with the one or more triggered measurement reporting.

7. The method of claim 1, wherein the UE prioritizes including a first beam of the first type of the one or more beams over a second beam of the first type of the one or more beams in the truncated beam report MAC CE based on quality of the first beam being higher than quality of the second beam.

8. The method of claim 1, wherein the first type of the one or more beams fulfills the entry condition by satisfying the entry condition for Time-To-Trigger (TTT), and the second type of the one or more beams fulfills the leaving condition by satisfying the leaving condition for TTT.

9. The method of claim 1, wherein the UE triggers the one or more triggered measurement reporting in response to the first type of the one or more beams fulfilling the entry condition and/or the second type of the one or more beams fulfilling the leaving condition.

10. The method of claim 1, wherein the one or more beams are one or more applicable beams of the event-triggered report configuration.

11. A User Equipment (UE), comprising:
a memory; and
a processor operatively coupled with the memory, wherein the processor is configured to execute a program code to:
be configured with an event-triggered report configuration associated with one or more beams;
determine to generate a truncated beam report Medium Access Control (MAC) Control Element (CE) in response to one or more triggered measurement reporting associated with the event-triggered report configuration; and
determine which beams among the one or more beams to be included in the truncated beam report MAC CE based on at least a type of each of the one or more beams, wherein: the UE prioritizes a first type of the one or more beams over a second type of the one or more beams, prioritizes the second type of the one or more beams over a third type of the one or more beams, and prioritizes the third type of the one or more beams over a fourth type of the one or more beams, and wherein: the first type of the one or more beams is one or more beams that fulfill an entry condition of the event-triggered report configuration and trigger the truncated beam report MAC CE, the second type of the one or more beams is one or more beams that fulfill a leaving condition of the event-triggered report configuration and trigger the truncated beam report MAC CE, the third type of the one or more beams is one or more beams that do not trigger the truncated beam report MAC CE and have been reported in a previous beam report MAC CE, and the fourth type of the one or more beams is one or more beams that do not trigger the truncated beam report MAC CE and have not been reported in a previous beam report MAC CE.

12. The UE of claim 11, wherein the UE determines to generate the truncated beam report MAC CE in response to the one or more triggered measurement reporting based on at least an Uplink (UL)-Shared Channel (SCH) resource available for a new transmission cannot accommodate a complete beam report MAC CE.

13. The UE of claim 12, wherein the complete beam report MAC CE is an event triggered Layer 1 (L1) measurement report MAC CE.

14. The UE of claim 11, wherein the event-triggered report configuration is L1/Layer 2 (L2) Triggered Mobility (LTM)-Channel State Information (CSI)-ReportConfig.

15. The UE of claim 11, wherein the truncated beam report MAC CE is a truncated event triggered L1 measurement report MAC CE.

16. The UE of claim 11, wherein the third type of the one or more beams does not fulfill an entry condition and/or a leaving condition of the event-triggered report configuration, and/or the third type of the one or more beams is included in a list containing one or more beams that were reported in a previous beam report MAC CE, and/or the third type of the one or more beams is not associated with the one or more triggered measurement reporting.

17. The UE of claim 11, wherein the UE prioritizes including a first beam of the first type of the one or more beams over a second beam of the first type of the one or more beams in the truncated beam report MAC CE based on quality of the first beam being higher than quality of the second beam.

18. The UE of claim 11, wherein the first type of the one or more beams fulfills the entry condition by satisfying the entry condition for Time-To-Trigger (TTT), and the second type of the one or more beams fulfills the leaving condition by satisfying the leaving condition for TTT.

19. The UE of claim 11, wherein the UE triggers the one or more triggered measurement reporting in response to the first type of the one or more beams fulfilling the entry condition and/or the second type of the one or more beams fulfilling the leaving condition.

20. The UE of claim 11, wherein the one or more beams are one or more applicable beams of the event-triggered report configuration.
